(19) United States
(12) Patent Application Publication
(10) Pub. No.: US 2026/0340448 A1
(43) Pub. Date: Oct. 29, 2026

(54) DATA ANNOTATION SYSTEM FOR TRAINING ARTIFICIAL INTELLIGENCE MODELS USING DATA SETS WITH EXCLUDED DATA POPULATIONS

(71) Applicant: PAYPAL, INC., San Jose, CA (US)

(72) Inventors: Zexia Zhou, Shanghai (CN); Shi Chen, Shanghai (CN); Shuoyuan Wang, Shanghai (CN); Boyu Tan, Shanghai (CN)

(21) Appl. No.: 19/188,581

(22) Filed: Apr. 24, 2025

(51) Int. Cl. G06N 5/04

(52) U.S. Cl. CPC G06N 5/04

(57) ABSTRACT

Computer security improvements relating to training AI models using data annotations of excluded data populations from training data sets are disclosed. A service provider may utilize a framework having computing operations for automated machine learning (ML) training data generation and model training using data that may be annotated without user input, efforts, and/or intervention. In this regard, the service provider may provide an ML modeling platform where training data may be generated and/or ML models trained with reduced human interaction for annotating data sets. Initially, a data set may be selected that may have annotated and unannotated data, where the unannotated data may correspond to a rejected, declined, or excluded data population that was not processed and therefore unannotated after processing. Data annotations may be automatically generated using riskiness evaluations and static AI models, and inferences may be made for semi-supervised learning.

### TECHNICAL FIELD

The present application generally relates to artificial intelligence (AI) models and systems, and more particularly to training such models and systems by annotating training data without human tagging that generates training data generation from excluded data populations.

### BACKGROUND

Artificial intelligence (AI) models and systems are widely used in enterprise applications due to their capabilities mimicking human thought and skill. These may be used to provide different computing services and platforms to users, who may access online domains and platforms to perform various activities, view information, and the like. These service providers may provide processes for account establishment and access, messaging and communications, electronic transaction processing, and other types of available services. Importantly, with certain computing services comes a risk of loss, fraud, computing attacks, data privacy breachers, and other malicious activity that may harm users and systems. As such, these service providers may implement risk and fraud systems, which may utilize AI models and techniques, such as machine learning (ML) models, neural networks (NNs), generative AIs, and the like, to identify and/or take actions such risks.

However, ML models and solutions require training on training data, which requires human efforts to identify, verify, and/or label fraudsters and/or fraudulent activities and transactions in training data sets, as well as generate data that may be used to test and summarize models after building. This requires significant manual efforts and is time consuming, which may hinder the ability of fraud detection systems to stay current with emerging fraud trends and activities. These solutions often require supervised learning, which is highly dependent on accurate tagging of bad, fraudulent, or malicious data. To fully mature a training data set, annotators may take months, introducing a significant delay in getting training data sets to modeling systems for model training. This delay may be significant enough to miss trends and/or allow fraud, which may cause significant loss. As such, there is need for a data annotation system that enhances and improves datasets having abnormal data populations from data exclusion in a faster and more efficient manner with accurate labels for A I model training.

### BRIEF DESCRIPTION OF THE DRAWINGS

FIG. 1 is a block diagram of a networked system suitable for implementing the processes described herein, according to an embodiment;

FIGS. 2A and 2B are exemplary diagrams of inferences determined for data records in a rejected data set that were rejected or declined for data processing by a data processor and do not have user annotations, according to an embodiment;

FIGS. 3A-3C are exemplary diagrams showing data and operations that may be used when determining inferences automatically and without user input and tagging based on a riskiness evaluation and/or static AI model score, according to an embodiment;

FIG. 4 is a flowchart for an anomalous signal detection using a machine learning pipeline for automated solution generation, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for an anomalous signal detection using a machine learning pipeline for automated solution generation. Systems suitable for practicing methods of the present disclosure are also provided. Note that while various examples, structures, techniques, etc. may be described with respect to a service provider in this specification, these structures, techniques, etc. are generalizable and are applicable to any entity that implements artificial intelligence (AI) training data generation and/or model training, for example, for machine learning (ML) models for anomalous signal processing and evaluation, according to various embodiments.

In network communications including interactions between online platforms and systems of service providers and client devices of end users, service providers may provide computing services to users and other entities through computing architectures. Provision of these services and corresponding computing architectures may face different types of computing attacks coming from malicious users and sources over a network. For example, a malicious actor may initiate a computing attack on the computing environment of the service provider that may compromise services (e.g., electronic transaction processing services) and/or expose data (e.g., personally identifiable information (PII) and/or funding source information) to the malicious actor. Computing attacks may be executed through automated computing bots or operations, such as executable scripts and bots that may quickly repeat computing attacks with different endpoints and/or internal users, employees, agents, and the like.

Further, with the advent of large language models (LLMs) and other generative AI systems, creating scripts, messages, text, emails, and other communications that may be personalized and targeted has become faster to automatically generate and deploy while adding layers of sophistication, volume, and reach that leads to more numerous and effective attacks. Computing attacks and activities that compromise data and accounts may lead to fraud and loss by the service provider, for example, when malicious and/or fraudulent parties perform account takeovers (ATOs), send or receive payments and funds in an unauthorized manner, and the like. Shell scripts may also automate other processes and operations, including program or application executables that automate execution of scripts for credential stuffing, social engineering attacks, and the like.

To better detect fraud, fraudulent transactions and/or accounts used by these bad actors and bots may be identified and signals for such transactions, accounts, and the like may be used to train AI models and systems to counteract activities engaged in by these bad actors, such as ML models for risk and fraud detection. Conventionally, this may require specific generation of training data, which is annotated and requires human oversight, tagging, annotation, and/or review for maturation into proper training data sets. However, as hackers and other malicious users or entities become more sophisticated, they may perform different computing attacks and other malicious conduct to compromise these communications. Without accurately and quickly identifying these attackers and performing remedial actions, the service provider may risk fraud, loss, and decreased customer trust or satisfaction. Although transaction processors and other online service providers may implement risk mitigation pipelines, these suffer from a few major drawbacks and vulnerabilities related to maturation of timely and accurate training data set having annotated data records for fraud or other data records of interest and those that may be valid, non-fraudulent, and/or used as the sampled baseline for authorized activities or other characteristic and/or parameter of the data records. As a result, current systems may not identify fraud or other attacks and activities that lead to loss in sufficient time to prevent or mitigate the activities, while generating and maturing (e.g., preparing for ML model training or other use with AI models and systems) accurate and timely data sets are costly due to the manual efforts, requiring extensive system resources.

As such, according to various embodiments, an online transaction processor or another online service provider may implement a security and fraud detection system for fraud and other malicious activities that automates processes for tagging transactions, accounts, users, entities, activities, or other data associated with data records in an excluded population that does not include human annotations and/or annotations already provided by another system, user, component, or the like. The annotations may be done with no or little human efforts and intervention, thereby allowing for automated and procedural (e.g., according to the steps and/or operations in a processing flow of unannotated data records from an excluded population in a data set) training data generation with data annotations. The training data may then, once annotated, be used to train an ML model automatically and with no or little human intervention (e.g., no “human-in-the-loop” or a minimal input and/or participation of the human in the loop for training data generation). This may be done by inferring tags and other data annotations of data records without processing corresponding requests for the data records and identifying actual labels based on processing results and/or post-processing activities (e.g., later indications of transaction reversal, fraud, etc.).

For example, to assist in preventing or minimizing fraud, computing attacks, and other service and product abuses, a service provider, in various embodiments, may utilize a framework for annotating unannotated data sets and/or subset within a larger data set for training data generation. Conventionally with machine learning, training of an ML model is dependent on the tagging of bad transactions or other anomalous data, data records and/or variables within data records, and the like. For example, conventional supervised learning requires a data scientist or other user responsible for tagging certain data records or other individual pieces of data (e.g., datum) within a data set with a particular tag, such as indicating the record or data as fraudulent or non-fraudulent for risk and fraud detection ML model training and inferencing on transaction data sets. This, however, requires individual user participation and input to create annotated data sets.

Therefore, the ML models may suffer from inaccuracy due to poor tagging, old data, and changes in trends, which may not be immediately caught and used for ML model training or other AI model generation and/or deployment. Since tagging in data sets requires time for manual inputs, solutions are not immediately deployable. To minimize the time required for training data generation and/or maturation for model training, a service provider may utilize, in various embodiments, an automated training data generator that provides a solution to these problems with existing risk models and training data availability. The automated training data generator may utilize specific knowledge and processes to infer data tags and other data annotations of data from an excluded, rejected, and/or declined population of data in a data set. A data set may be segmented or segregated into annotated and/or unannotated data. For example, for a transaction data set, the data set may include approved transactions and rejected transactions, where data records for transactions in the approved transaction data subset may have been annotated after approval based on post-transaction processing labeling by data scientists, users, and/or fraud specialists. This may occur when approved transactions are reviewed for fraud, reversed (e.g., based on customer/merchant requests, after fraud review, etc.), or otherwise found to be unapproved, illegal, illicit, fraudulent, or the like, while approved transactions may be found to be legitimate on further approval or by nature of not being reversed. However, with unapproved or declined transactions, no labels may be generated by the transaction processor as the transaction may be declined and no further action taken.

With the unapproved, declined, rejected, or otherwise unapproved transactions, data records, or other data in the unannotated data subset, a reject inference may be performed by the automated training data generator for data annotations. This may be performed by the training data generator so that the unannotated data may be procedurally and/or automatically tagged with data annotations, and the data having the inferred tags may be used to bolster and improve ML or other AI model performance and training. The models to be trained may include ML models, deep learning models (e.g., neural networks (NNs) and/or deep NNs (DNNs)), generative AIs (e.g., LLMs), and the like, which may be trained on newer trends in data records, fraud, and/or other user activities, thereby providing more efficient and up-to-date training data generation, timely ML or other AI model training, and automated processes that remove or reduce the need for human efforts and input during data annotation, which can be time consuming, inaccurate, and costly.

As such, the automated training data generator may provide a data annotation system to add to or generate labels for data for enhanced or improved training data. This improved training data may include data records from normally excluded data populations that have been annotated automatically by computer and/or machine processes. The training data may, after tagging the unannotated data has been performed, then include data records and/or subsets of data from a desired or selected training data set that were previously unannotated and therefore not used for supervised ML model training (or other AI model training that may use annotated data records). This enhanced training data having data annotations that may include procedurally or automatically generated labels and tags by the automated training data generator may enable an ML modeling platform may train more accurate, robust, and improved ML models or other AI models, rules, and/or engines. In this regard, a data annotation system as described herein may utilize a “reject inference” process and technique that incorporates statistical techniques, AI decision-making, ML and other A I models, and other automated techniques for inferring the performance of the declined (or other) population. Inference of tags and other labels may be performed by utilizing information present in the approved population, as well as scores and the like from other components and available data. For example, since a card domain may not have previously used or possessed a control group, the data annotation system may label some bad/good transactions from the declined population according to other activities under the same financial instrument, account, user, or other link to the declined population that may have movement flows of funds that may been predicted and good/bad with a high confidence level. Further, if the user had been declined in the card domain for “addfund” but used the same bank card to perform peer-to-peer (P2P) transactions that were approved but labeled as bad, then the system may have a higher confidence this “addfund” transaction was bad or otherwise fraudulent and/or unapproved.

These operations and components may generate a data set having the original data, as well as additional labels for the data for certain data points that are correlated with likely being good, bad, or other classification. For example, transactions may be identified for their likelihood of fraud, and labels may be added to unlabeled transactions, such as with reject_inference_good or reject_inference_bad labels or similar tags. To verify the accuracy and recall of the reject inference logic of the data annotation system and automated training data generator, the process may be applied to the approved population to determine a frequency, rate or other metric by which the approved transactions and/or cards for those transactions have data features, variables, characteristics, or other attributes that may have many or few similar links to fraud transactions. After the data annotation system adds or otherwise enhances the data set with the reject_inference_good and reject_inference_bad labels for corresponding unlabeled data, such as to transactions from a declined population into the training dataset, the service provider may observe a significant catch rate lift (or identify fraudulent transactions, including how many overall bad transactions can be captured at a certain action rate) in the out-of-training population, and even in the approved out-of-training population.

As such, training data sets may be expanded and include the normally excluded data, such as data from data records that were declined or rejected from being processed and do not include a post-data processing annotation or tag. This allows for more comprehensive and robust AI model training by training on a fuller set of data records, data points, or the like from training data. Since there may be a significant and large population of declined transactions or other data records that were initially declined, refused, or rejected for data processing, no further processing may be performed and therefore no fraudulent or non-fraudulent data tag may have been generated for the transaction. However, the present system may provide fast and efficient training of AI models that are accurate on data sets that conventionally would cause improper or inaccurate model training and inferencing. As such, the data annotation system and solution described herein may be used in domains where training data may conventionally be found to be insufficient or lacking certain data points or distribution to the data points. For example, if the data set includes too many or too few data associated with fraud in a transaction data set, models may be improperly trained. For example, in a card processor domain for payment card transactions, a model may be trained or may be trained on data for when a user attempts to add funds to a card account with their bank financial instruments but receives the response of “UNAUTH/SF bad” when the transaction is incorrect, fraudulent, or otherwise denied. Where the transaction processor did not previously have a control group, models may have only been trained on the approved population, which causes issues with model performance.

As such, in certain domains, there may be issues when the data set is imbalanced or improperly represents a certain population, demographic, annotation, or the like. In this case, the domain may have a large number of declines and a large decline rate or percentage of the population, which skews model training. A significant portion of the population may therefore be excluded due to insufficient tagging, which causes a gap between the model's training and the actual traffic in a live inferencing environment since the model is not fully trained and/or not trained on the latest unlabeled data. Further, with a large decline rate, it may be difficult for ML models, algorithms, and training techniques to train models accurately with unbalanced data. However, by providing operations to create, label, annotate, and/or enhance training data sets where a larger number of good and/or bad transactions or other data records and annotations are identified in the training data set, AI models may be made more accurate in identifying or predicting fraudulent transactions. This provides an enhanced training data set that may provide more accurate training of ML or other AI models. Consequently, ML model training, and other AI system training and/or generating, may be done quickly, more accuarately, and efficiently without significant time or resources for manual review and user annotation. As such, the service provider may improve the acquisition and labeling of training data sets for more efficient and accurate ML model training, which improves ML modeling systems and techniques, as well as provides more accurate and improved ML models and other AI systems. The use and improvement of technology underscores the improvements provided to the technical problems with identification of accurate and representative training data sets, and implementing accurate and timely AI solutions to problems arising from activities occurring in those data sets.

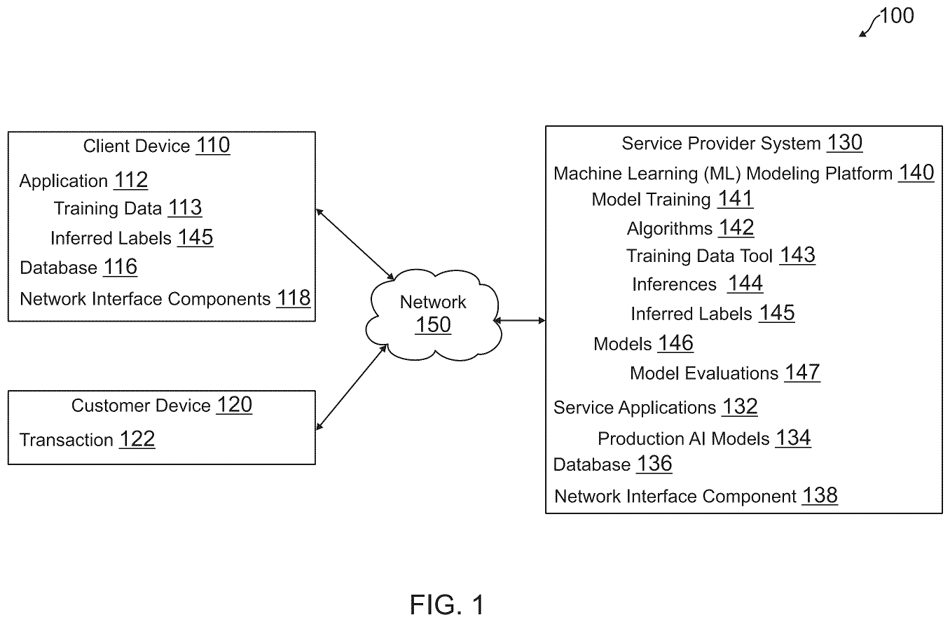

FIG. 1 is a block diagram of a networked system 100 suitable for implementing the processes described herein, according to an embodiment. As shown, system 100 comprises or implements a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, a mobile OS (e.g., IOS, Android, Google OS, etc.), a merchant and/or point-of-sale (POS) device OS, or another suitable device and/or server-based OS. It can be appreciated that the devices and/or servers illustrated in FIG. 1 may be deployed in other ways and that the operations performed, and/or the services provided by such devices and/or servers may be combined or separated and may be performed by a greater number or fewer number of devices and/or servers. One or more devices and/or servers may be operated and/or maintained by the same or different entity.

System 100 includes a client device 110, customer devices 120, and a service provider system 130 in communication over a network 150. Client device 110 may be utilized by a user, such as an employee of an entity associated with service provider system 130, to engage in activities with other computing devices, servers, and systems over network 150, including those associated with communications in one or more communication channels, such as a service channel or assistance channel. Service provider system 130 may provide various data, operations, and other functions over network 150 to provide services to client device 110 and/or other devices of users, which may include electronic transaction processing. In this regard, client device 110 may utilize an account to engage in communications, which may be processed by service provider system 130 to identify fraud and other illegal, illicit, or unauthorized activities that may be associated with social engineering attacks or other computing attacks.

Client device 110, customer devices 120, and service provider system 130 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

Client device 110 may be implemented as a communication device of a data scientist or other internal user associated with service provider system 130 that may be involved in ML modeling for training ML models. Client device 110 may utilize appropriate hardware and software configured for wired and/or wireless communication with service provider system 130. For example, in one embodiment, client device 110 may be implemented as a personal computer (PC), a smart phone, laptop/tablet computer, wristwatch with appropriate computer hardware resources and/or other type of wearable computing device, implantable communication devices, and/or other types of computing devices capable of transmitting and/or receiving data. Although only one device is shown, a plurality of devices may function similarly and/or be connected to provide the functionalities described herein.

Client device 110 of FIG. 1 includes and/or is associated with an application 112, a database 116, and a network interface component 118, implementations of which are discussed further below. Application 112 may correspond to executable processes, procedures, and/or applications with associated hardware. In other embodiments, client device 110 may include additional or different modules having specialized hardware and/or software as required.

Application 112 may correspond to one or more processes to execute software modules and associated components of client device 110 to provide features, services, and other operations for an internal user, data scientist, and/or administrator for use with service provider system 130when generating training data and/or training ML and other AI models and engines based on the training data. As such, application 112 may provide access to computing services provided by service provider system 130 (e.g., for ML modeling and/or other AI training and/or configuring). In this regard, application 112 may correspond to specialized software utilized by a user of client device 110 to generate and transmit training data 114 to service provider system 130 for processing and training of an ML model, which may include generating and/or tagging excluded data populations in training data 114 with data annotations, such as data tags or labels that may be automatically and/or procedurally generated by service provider system 130. In some embodiments, training data 114 may include annotations of a subset of the data records, data points, or other included data, such as tagging and/or labeling of a subset or segmented population of the data in the data set. However, training data 114 may also have an unlabeled, untagged, or otherwise unannotated subset of data, such as an excluded population of the data in the data set. In some embodiments, training data 114 may correspond to a transaction data set, where the labeled data may correspond to approved transactions labeled as fraudulent or non-fraudulent, and the unlabeled data may correspond to rejected or declined transactions (e.g., those with a high enough likelihood of risk, fraud, ATO activity, or the like that the transaction was not processed) that do not have tags or labels identifying each transaction as actually fraudulent or non-fraudulent as identified by human review and/or annotations or other criteria for data annotations of labels or tags.

Training data 114 may be processed to determine inferred labels 145 by service provider system 130, as discussed herein. Inferred labels 145 may be automatically generated labels, which may correspond to labels or tags automatically generated using one or more procedures and/or in accordance with a technique where algorithms and/or machine coded techniques, rather than human reviewers and/or annotators, create the labels or tags of the data. As such, automated and/or procedural generation of inferred labels 145 may be performed by service provider system 130 and provided to client device 110 for review, approval, or revisions/changes. Inferred labels 145 may be generated based on a riskiness evaluation and/or scoring using a static model, which may be performed when generating training data for ML model training. ML model training may then be performed to train an ML model, such as for risk and/or fraud prediction and detection, as discussed herein. As such, application 112 may be used to provide, engage in, and/or transmit training data 114 via one or more communications, messages, services, and/or channels of service provider system 130.

Training data 114 may include transactions and corresponding content, such as messages including text, media (e.g., audio, video, image, etc.), and/or other information associated with one or more products, services, or other items to be purchased and/or paid for using an account and/or payment instrument. In some embodiments, training data 114 may include and/or be associated with additional transaction data, user or merchant information, a financial account number or other financial data, a user identification, a device identifier, account data, or other information. Application 112 may correspond to a general browser application configured to retrieve, present, and communicate information over the Internet (e.g., utilize resources on the World Wide Web) or a private network. For example, application 112 may provide a web browser, which may send and receive information over network 150, including retrieving website information, presenting the website information to the user, and/or communicating information to the website. However, in other examples, application 112 may include a dedicated application of service provider system 130 or other entity that may interact with service provider system 130.

Application 112 may provide one or more user interfaces, for example, via GUIs presented using an output display device of client device 110, to enable the user associated with client device 110 to utilize computing services, platforms, and applications of service provider server with accounts, which may request execution of computing operations through user interface commands and other user inputs. In some embodiments, the GUI, when viewed by a data scientist, administrator, or the like that may provide access to different resources and digital platforms for ML model training, may display and/or provide information regarding ML model training, such as inferred labels 145 and/or results of training data labeling and/or generation. Further, the GUI may provide information regarding training of ML models based on generated training data, which may include training results from training of an ML model using inferred labels 145 with additional labeled data in training data 114.

Client device 110 includes other applications as may be desired to provide features to client device 110. For example, these other applications may include security applications for implementing client-side security features, programmatic client applications for interfacing with appropriate application programming interfaces (A Pls) over network 140, or other types of applications. Other applications on client device 110 may also include email, texting, voice and IM applications that allow a user to send and receive emails, calls, texts, and other notifications through network 150. In various embodiments, the other applications may include those that may be utilized in the course of ML model training and other AI modeling, training, rule or engine creation, and the like. The other applications may include device interface applications and other display modules that may receive input from the user and/or output information to the user. For example, client device 110 may contain software programs, executable by a processor, including a graphical user interface (GUI) configured to provide an interface to the user. The other applications may use devices of client device 110, such as display devices capable of displaying information to users and other output devices, including speakers.

Client device 110 may further include or have access to database 116, which may correspond to different types of data storage and components including cloud computing storage nodes, remote data stores and database systems, distributed database systems over network 150, and the like used to store various applications and data. Database 116 may include, for example, identifiers such as operating system registry entries, cookies associated with application 112 and/or other applications, identifiers associated with hardware of client device 110, or other appropriate identifiers, such as identifiers used for payment/user/device authentication or identification, which may be communicated as identifying the user/client device 110 to service provider system 130.

Client device 110 includes at least one network interface component 118 adapted to communicate with service provider system 130 and/or other devices and servers. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Customer devices 120 may correspond to different sources of transactions 122, such as different computing devices including mobile devices, personal computers, wearable/implantable computing devices, and other types of client computing devices that may communicate engage in data processing and/or communicate data associated with data processing for electronic transactions. As such, customer devices 120 may include client devices but may also correspond to other devices, servers, and/or endpoints that may provide, generate, request processing of, and/or process transactions 122. In some embodiments, transactions 122 may include the same or similar transactions in the data set of training data 114 provided for ML model training by application 112 on client device 110. As such, transactions 122 may be associated with labeled and/or unlabeled transactions, which may be labeled/tagged based on fraudulent activity, likelihood, or identified fraud. However, where transactions 122 correspond to rejected, declined, and/or excluded transactions, the excluded population of transaction 122 may be unlabeled and therefore require labeling by service provider system 130 prior to model training. Further, although transactions and transaction data are discussed as being used for training data 114, transactions 122 may correspond to any data, transmitted over network 150, that may be analyzed by service provider system 130 for tagging and/or labeling. Transactions 122, and in particular, anomalous, fraudulent, risky, or the like from transactions 122, may be used for ML model training using the training data generation and ML model training discussed herein.

Service provider system 130 may be maintained, for example, by an online service provider, which may provide computing services and digital products via one or more digital platforms, applications, websites, and the like. Service provider system 130 may provide computing services to various entities, which may implement security and fraud detection and prevention systems using an ML modeling process to automate generation of training data sets through automatically and/or procedurally generated tags and labels for excluded data populations. This training data may then be used to perform automated ML model training, as discussed herein. In one example, service provider system 130 may be provided by PAY PAL®, Inc. of San Jose, CA, USA. However, in other embodiments, service provider system 130 may be maintained by or include another type of service provider.

Service provider system 130 of FIG. 1 includes an ML modeling platform 140, service applications 132, a database 136, and a network interface component 138. Service applications 132 and/or ML modeling platform 140 may correspond to executable processes, platforms, applications, and/or associated content and data with corresponding hardware. In other embodiments, service provider system 130 may include additional or different applications, platforms, and modules having corresponding hardware and/or software as required by their corresponding embodiments.

ML modeling platform 140 may correspond to one or more processes to execute modules and associated specialized hardware of service provider system 130 to provide an ML pipeline, framework, and/or system that may be used to generate ML models or other AI models, systems, rules, and/or components trained with no or minimal human efforts performed to tag, label, and/or annotate data in an excluded data population for a training data set. In some embodiments, the AI models trained and/or configured using the training data generation techniques discussed herein may be used to detect fraudulent behavior and/or computing attacks, or perform other anomaly detection, as discussed herein. Although ML modeling and ML training is discussed in reference to ML modeling platform 140, for example, to cause a machine to learn from past data for pattern recognition and learning, other types of A Is may utilize the techniques described herein when annotating training data in an automated and procedural manner for model training. In some embodiments, the ML modeling platform 140 may correspond to specialized hardware and/or software used for training and/or implementing ML models including NNs and other deep learning models for identification of behaviors, activities, patterns, or other activities, behaviors, and/or signals of interest that indicate fraud, risk, malicious actions, computing attacks, or other anomalous signals. In this regard, ML modeling platform 140 may be used to perform inferences and/or classifications based on the ML models trained, as described herein, to provide risk and fraud detection services by service provider system 130.

ML modeling platform 140 may execute a model training 141 of one or more ML or AI models that may be configured to train the model(s) based on a training data set that includes annotations of excluded data from an excluded population in a training data set. In this regard, model training 141 may be used to generate and mature training data 114 and train one or more ML models or other AI models, engines, and/or systems including rule-based AI engines, deep learning models, and the like based on training data 114 having inferred labels 145 and using algorithms 142 that correspond to the ML or other AI algorithms, techniques, computations, or the like usable to train ML models and the like. In some embodiments, training data 114 may be received, or may be identified for training from online data including data obtained from a production computing environment (e.g., network activities and/or data logs, data processing requests and results, etc.). However, training data 114 may include different populations of data, and may be segmented or segregated according to those populations. As such, during model training 141, conventionally, not all of the data may be used. For example, with supervised ML model training, labeled training data may be required, which may have annotations of data records or the like in a data set that may be “matured” or ready for model training. However, where training only occurs after all of the training data is annotated, this annotation process for data records conventionally does not occur in real-time or based on post-processing of data that occurs quickly after data processing and/or in real-time and/or near real-time (NRT). As such, a gap exists between occurrences of fraud or other activity, behaviors, or signals of interest, and the time at which an ML model can be trained for corresponding detection.

Model trained 141 may utilize a training data tool 143 to generate training data by automatically and/or procedurally generating labels or tags of unannotated data through statistical analysis and algorithmic processing. Training data tool 143 may determine inferences 144, which may be obtained by analyzing the excluded data set that is unlabeled in training data 114 or other training data set. For example, with transaction data sets, rejected or declined transactions may be unlabeled as “fraudulent” or “non-fraudulent” as merely a risk analysis has been performed without subsequent labeling or tagging by a user and human activity. As such, although the rejected transactions were rejected for data processing, no actual determination of whether each transaction rejected was fraudulent or not has been made.

Consequently, training data tool 143 may determine additional data records or other particular pieces of data or datum that may have matching characteristics or properties over a time period, such as by having one or more of the same values for particular data variables or features of an ML model to be trained. Training data tool 142 may then determine if these data records have labels, and, if so, may then utilize the labels to make inferences regarding the unlabeled data records. In this regard, data records in the excluded population may be labeled according to similar data records in the labeled or included population of data records. For example, with a rejected transaction in the excluded data set that do not have labels, a lookup according to the same financial instrument and the same user may be performed over a corresponding time period, time frame, or window of time (e.g., last 24 hours before the transaction, next 24 hours, past and next 12 hours, etc.). If those transactions were approved, but were then found to be fraudulent, it may be inferred that the rejected transaction and transaction processing request was also fraudulent.

However, if those transactions were approved and also labeled as valid or non-fraudulent, it may be inferred that the rejected transaction was a good or non-fraudulent transaction request and attempt but declined for other reasons (e.g., network timeout, typographical error, network connectivity error or communication error, invalid card reading event, bandwidth issue, server timeout or error, etc.). These other data records may be identified in other data flows and/or account statuses and therefore may be correlated from other data sets. Selection of the data variable to perform lookup and correlation of data records (e.g., by user, financial instrument identifier, etc.) may be configured depending on the desired records to be identified and/or accuracy of inferences 144 after correlating data records and determining inferences 144.

As such, inferences 144 may be used to generate inferred labels 145 by statistically analyzing similar data records having matching values for one or more data variables. A riskiness evaluation of training data tool 143 may evaluate the unannotated data records according to other annotated data records that are matched based on the data variable(s). Further, a loss rate may be used to determine the riskiness evaluation, or other metric of interest when determining riskiness of the transaction. For example, a total payment volume (TPV) of a merchant customer may be used to weight or adjust the value of different data records when performing the riskiness evaluation, and an output of inferences 144 may depend on the metric used to evaluate the data records corresponding to the unannotated data record being annotated by training data tool 143. In further embodiments where a control group may be available, such as a group of similar transactions that have been labeled and on which a static model may have been trained, the static model created and/or trained for the control group may be used to score the unannotated data records. A score cutoff may be used as the metric for evaluating the riskiness of the unannotated data record, and a riskiness determination, or other determination of the tag, label, and/or annotation of the data record, may be output.

Thereafter, the excluded data population initially without data tags or labels may now be annotated with inferred labels 145 based on inferences 144 made by the riskiness evaluation or static model analysis according to the metric for evaluation. Inferred labels 145 may be added to training data 144, which may be used with the annotated data from included data set having the data annotations previously provided or made. Training data 114 with inferred labels 145 may then be used for training of models 146, which may be evaluated in accordance with a model evaluation 147. Models 146 may correspond to and/or provide classifiers, predictors, and the like configured to classify data, such as transactions and/or account activities, as fraudulent (e.g., fraud, ATO transaction, etc.), risky, engaging in a computing attack or malicious behavior, or likely to do so, and/or engaging in another corresponding activity, behavior, or the like.

Models 146 may be trained for use with service applications 132 using the training data automatically generated and/or determined in the manner discussed herein, such as once training data 114 having inferred labels 145. Models 146 may include and/or correspond to different types of ML models (clustering, decision trees, NNs, DNNs, LLMs and other generative AIs). Models 146 may have trained layers based on training data and selected features or data variables configured for alert and/or anomalous signal detection and classification. For example, ML features or data variables may correspond to individual pieces, properties, characteristics, or other inputs for an ML model and may be used to cause an output by that ML model once the ML model has been trained using data for those features from training data. Models 146 may be used for computation and calculation of model scores based on layers, nodes, branches, clusters, rules, and the like that are trained and optimized. As such, models 146 may be trained to provide a predictive output, such as a score, likelihood, probability, or decision, associated with a particular prediction, classification, or categorization.

Models 146 may include DNNs, ML clustering or decision tree models, LLMs, generative AIs, or other AI models trained using training data having data records that have columns or other data representations and stored data values (e.g., in rows for the data tables having feature columns) for the features. When building and/or training models 146, training data may be used to generate one or more classifiers and provide recommendations, predictions, or other outputs based on those classifications and an ML or NN model algorithm and architecture. The algorithm and architecture for models 146 may correspond to DNNs, ML decision trees and/or clustering, conversational AIs, LLMs, generative AI, and other types of AI, ML, and/or NN architectures. The training data may include data variables using as input features and/or be used to determine features, such as through feature extraction and feature selection using the input training data.

Where models 146 include DNNs and other ML models, DNN models may have one or more trained layers, such as an input layer, a hidden layer, and an output layer having one or more nodes; however, different layers may also be utilized. As many hidden layers as necessary or appropriate may be utilized, and the hidden layers may include one or more layers used to generate vectors or embeddings used as inputs to other layers and/or models. In some embodiments, each node within a layer may be connected to a node within an adjacent layer, where a set of input values may be used to generate one or more output values or classifications. Within the input layer, each node may correspond to a distinct attribute or input data type for features or variables that may be used for training and intelligent outputs, for example, using feature or attribute extraction with the training data.

Thereafter, the hidden layer(s) may be trained with this data and data attributes, as well as corresponding weights, activation functions, and the like using a DNN algorithm, computation, and/or technique. For example, each of the nodes in the hidden layer generates a representation, which may include a mathematical computation (or algorithm) that produces a value based on the input values of the input nodes. DNN, ML, or other AI architecture and/or algorithm may assign different weights to each of the data values received from the input nodes. The hidden layer nodes may include different algorithms and/or different weights assigned to the input data and may therefore produce a different output value based on the input values. The values generated by the hidden layer nodes may be used by the output layer node(s) to produce one or more output values for ML models that attempt to classify and/or categorize the input feature data and/or data records. Thus, when models 146 are used to perform a predictive analysis and output, the input data may provide a corresponding output based on the trained classifications.

Layers, branches, clusters, or the like of models 146 may be trained using training data associated with data records of interest, such as data sets including one or more of transactions 122. By providing training data, the nodes in the hidden layer may be trained (adjusted) such that an optimal output (e.g., a classification) is produced in the output layer based on the training data. By continuously providing different sets of training data and/or penalizing models 146 when the outputs are incorrect, models 146 (and specifically, the representations of the nodes in the hidden layer) may be trained (adjusted) to improve its performance in data classifications and predictions. Adjusting models 146 may include adjusting the weights associated with each node in the hidden layer.

Model evaluations 147 may include ML or other AI model performance metrics and analytics, such as accuracy, inference speed, and the like. Further, model evaluations 147 may include a summary of the training data and generation of inferred labels 145. In this regard, a generative AI, such as a language model (e.g., an LLM or the like) may be configured to generate natural language text used to summarize the creation of training data and/or maturation of the training data for ML or other AI model training. For example, a summary may be provided that includes information regarding determination of inferences 144 and/or creation of inferred labels 145. ML modeling platform 140 may be configured to output the summaries with models 146 for analysis and/or determination of deployment and/or instructions for use or retraining. Summaries and other information for models 146 may be output via a GUI, which may further present the information with any other relevant metric, analytic, or additional data that may assist a user when reviewing and/or determining the accuracy of models 146.

Service applications 132 may correspond to one or more processes to execute modules and associated specialized hardware of service provider system 130 to process a transaction and/or provide other computing services to users. For example, service applications 132 may be used to process payments and other services to one or more users, merchants, and/or other entities for transactions, where use of those services, applications, websites, data, and the like may include use of production AI models 134, which may include one or more of models 146 selected for product AI uses and services. Production AI models 134 may be selected and used for predictive inferencing and/or other outputs including fraud detection and/or computing attack mitigation. In this regard, users, including merchants and other entities, as well as customers and individual users, may establish a digital account for engagement with the products and services of service provider system 130. For example, the account may be used to send and receive payments, including those payments that may be enabled through a website and/or application of users, merchants, and other transaction participants. A payment account may be accessed and/or used through a browser application and/or dedicated payment application executed by a device, such a digital wallet application and/or a mobile payment application. Service applications 132 may process payments and may provide transaction histories to customer devices 120 and/or another user's device or account for transaction authorization, approval, or denial of the transaction.

In further embodiments, service applications 132 may provide different computing services to users and entities, including social networking, microblogging, media sharing, messaging, business and consumer platforms, etc. Use of these computing services may require use of production AI models 134, for example, for fraud detection and/or risk assessment with transaction processing services. As such, service applications 132 may be integrated with ML modeling platform 140 for use and/or deployment of one or more of models 146 once trained. For example, accounts may be used with service applications 132 to engage in different account activities, such as electronic transaction processing requests. Transactions 122 may be requested for transaction processing and/or processed using one or more of service applications 132.

Service applications 132 may also provide additional features to service provider system 130. For example, service applications 132 may include security applications for implementing server-side security features, programmatic client applications for interfacing with appropriate A PIs over network 150, or other types of applications. Service applications 132 may contain software programs, executable by a processor, including one or more GUIs and the like, configured to provide an interface to the user when accessing service provider system 130, where the user or other users may interact with the GUI to view and communicate information more easily. Service applications 132 may include additional connection and/or communication applications, which may be utilized to communicate information to over network 150.

Additionally, service provider system 130 includes or may access database 136. Database 136 may store various identifiers associated with client device 110, as well as account data, including payment instruments, financial information, account balances, and authentication credentials, as well as transaction processing histories and data for processed transactions. Database 136 may include information for accounts and/or transactions, including transactions 122 that may be used for inference of labels and tags for unannotated data subsets or populations in a larger training data set. Although database 136 is shown as residing on service provider system 130 as a database, in other embodiments, other types of data storage and components may be used including cloud computing storage nodes, remote data stores and database systems, distributed database systems over network 150 and/or of a computing system associated with service provider system 130, and the like.

Service provider system 130 may include at least one network interface component 138 adapted to communicate client device 110, customer devices 120, and/or other devices and servers over network 150. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency (RF), and infrared (IR) communication devices.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

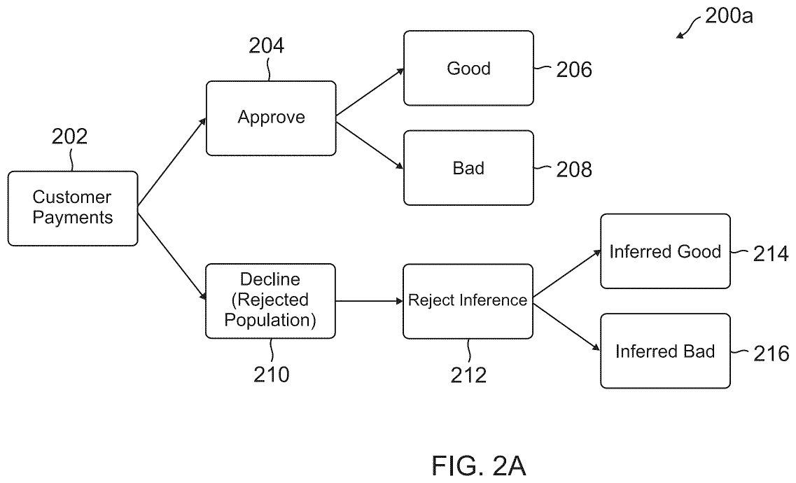

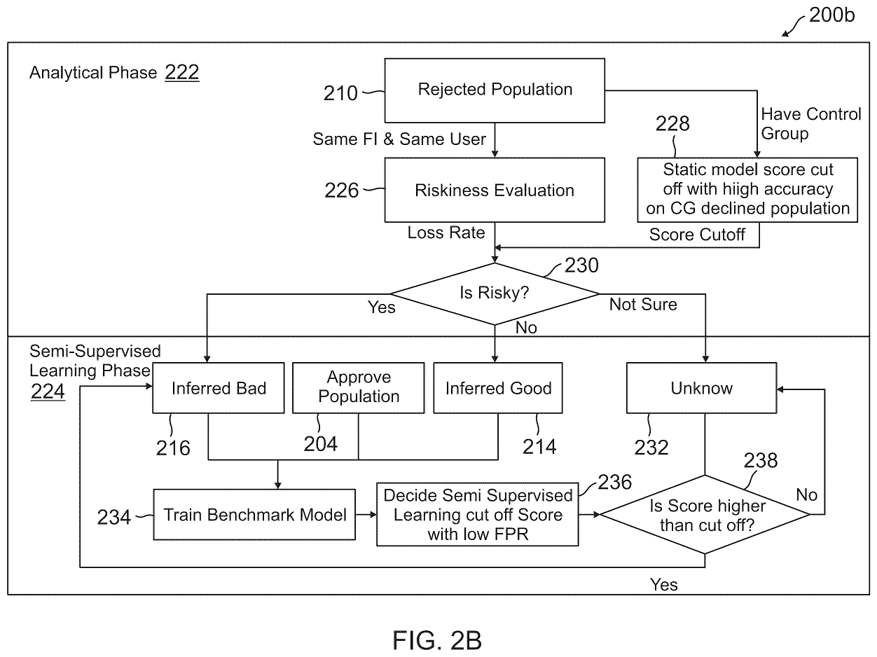

FIGS. 2A and 2B are exemplary diagrams 200a and 200b of inferences determined for data records in a rejected data set that were rejected or declined for data processing by a data processor and do not have user annotations, according to an embodiment. Diagram 200a shows a representation of the data processing flow for annotating data sets including automatically generated annotations for excluded data populations as performed by ML modeling platform 140 for service provider system 130, discussed in reference to system 100 of FIG. 1. Diagram 200b shows a more granular representation of the data flow, operations, and decisions for annotating data for excluded data populations and training ML models by ML modeling platform 140.

In diagram 200a of FIG. 2A, a plurality of customer payments 202 have been initially processed as approved payments 204 or declined payments (or rejected populations) 210. Customer payments 202 may correspond to a type of transaction, such as payments from customers to merchants, which may utilize a transaction processor for payment processing. The transaction processor may provide a risk and fraud detection system that may initially classify transactions for risk and/or fraud. Customer payments 202 may initially be assessed for fraud by the fraud detection system of the transaction processor. Approved payments 204 may correspond to the set or population of transactions from customer payments 202 that are determined to be non-fraudulent or not risky, such as if risk scores determined by an ML model trained for risk analysis of the transactions are below or at a risk threshold, over which, the transactions may be considered risky and rejected or declined. In contrast, declined payments 210 may correspond to the rejected or declined set or population of transactions from customer payments 202 that meet or exceed this risk threshold when similarly scored.

With approved payments 204, the transaction and corresponding payments may then be processed, which includes an actual payout of a payment amount from one account to another account. As such, approved payments 204 may further be reviewed and annotated with real labels indicating a final adjudication or decision on fraud or risk of approved payments 204. For example, during post-payment processing, approved payments 204 may be tagged or labeled with a good tag 206 or a bad tag 208. Good tag 206 may arise when further processing does not identify any indication of fraud and/or when the corresponding transaction and/or payment is not reversed, disputed, or otherwise indicated as fraudulent by one or more of the parties engaged in the transaction. However, bad tag 208 may result when one or more of the parties dispute the transaction, the transaction is reversed, or other indication of fraud becomes apparent, and the transaction is reviewed and/or handled as fraudulent. As such, annotations of approved payments 204 may be generated for the data set of customer payments 202.

However, with declined payments 210, no further processing is necessary after being declined. Instead, if the transaction and payment were validly requested, users are generally requested to retry the transaction and payment, such as by providing their card information a second or further time. As such, no labels are generated, and when training ML models using supervised training, declined payments 210 would represent an excluded data population of data records, which would not be used for model training, thereby limiting the pattern recognition of traits, characteristics, data variables, and the like that may be learned by a machine when training the ML model (e.g., when configuring algorithms, weights, activation functions, etc.,) to make inferences and predictions on similar data sets in real-time or with new data. Further, declined payments 210 may represent a significant portion of customer payments 202 since payments may be declined for many non-fraudulent reasons (incorrect data input and entry, network errors, card reader errors, etc.).

As such, and as further detailed in diagram 200b of FIG. 2B, a reject inference 212 may be determined for each of declined payments 210, which may be used to automate training data generation through annotating data. For example, reject inference 212 for a transaction and/or payment may correspond to a process by which an inferred good 214 or an inferred bad 216 label is determined and generated for the excluded population from customer payments 202, which is declined payments/rejected population 210. When generating a label for inferred good 214 and/or inferred bad 216, an evaluation process or technique may be utilized, such as a riskiness evaluation when comparing each unlabeled data record to similar data records from approved payments 204 or other data set having labels or tags (e.g., from annotated data sets). The evaluation process may instead correspond to use of a static model if a control group is available. As such, inferred good 214 may correspond to inferring that an unlabeled data record (e.g., transaction and/or payment) has a good, valid, or non-fraudulent label, while inferred bad 216 corresponds to the opposite where the unlabeled data record may be inferred to be bad, invalid, or fraudulent.

In diagram 200b, an analytical phase 222 and a semi-supervised learning phase 224 may be used to determine reject inferences 212 for each data record in declined payments/rejected population 210, the excluded data population of unannotated data records, so that declined payments 210, or a subset of the corresponding data set for declined payments 210, may be used for ML model training and/or incorporated with annotated training data in the training data set. As such, declined payments 210 (the rejected population of transactions) may be analyzed according to different evaluation processes and/or procedures. If a control group is not available and/or if analysis according to similar matching transactions or other data records is desired, a riskiness evaluation 226 may be performed based on other transactions and/or data records that include certain matching characteristics, parameters, or the like, such as matching values for variables that have been selected or identified for record searching and matching.

Riskiness evaluation 226 may be performed based on an evaluation of activity of data records having the matching values over a time period (e.g., +/−n minutes/hours/days/weeks or similar time), as well as a metric for evaluating the riskiness (e.g., number of transactions having good tag 206 or bad tag 208, TPV, loss rate, etc.). Riskiness evaluation 226 may be based on a statistical analysis and/or computed score of riskiness from correlating the data records. With an available control group, a static model 228 may be used with a score cut off, such as a selected score threshold based on a high accuracy of correct labeling in the control group with the declined data population. As such, a static ML model, such as one that does not implement continuous learning or the like and is previously trained for transaction scoring or other scoring of data records, may be used to determine a score for a transaction or other data record and compare that score to the score cutoff or other metric for determination of riskiness based on the output of the static model

As such, using either of the evaluation processes, a riskiness determination 230 is made during analytical phase 222. The riskiness determination 230 may be used to label the corresponding data record. In this regard, the data record may be labeled with inferred good 214 or other similar label or tag if riskiness determination 230 results in the data record not being determined to be risky or have other corresponding inference. As such, those data records not being inferred to be risky during riskiness determination may be labeled as “good” (or “inferred good,” if model training may distinguish between good and inferred good labels), and may be added to the training data set. However, where it is determined that the data record is risky (or where another inference is made for the data record), in semi-supervised learning phase 224, the data record is instead provided the label of inferred bad 216, or other similar label or tag for the corresponding inference. A “bad” (or “inferred bad,” if permitted by the model training) label may be added to those data records for use in the training data set.

A training data set may then be generated using the newly labeled data from the rejected population of declined payments 210. Approved payments 204 with corresponding labels may be combined with the automatically and procedurally labeled data records labeled with from riskiness determination 230 with inferred good 214 or inferred bad 216. As such, the training data set may include data records from the initially excluded data population, which are now included based on labeling and/or tagging automatically using the aforementioned processes.

With certain data records, riskiness determination 230 may result in an unknown determination 232 for data labeling. This may occur when the output score or determination of riskiness is not sufficient to qualify as either risky or not risky, such as where the score or other output falls between thresholds or cutoffs for riskiness determination. These may initially be set aside until after a benchmark model 234 is trained. When training benchmark model 234, the aforementioned training data having the newly labeled transactions or other data records from the rejected population of declined payments 210 with the approved population having labels from approved payments 204. Training may be performed using one or more ML model training techniques, algorithms, and/or the like, which may result in benchmark model 234 that may be used for testing of model performance and assessment of unknown determination 232 for other data records. With benchmark model 234, a semi-supervised cutoff score 236 may be determined, which may be set to have a false positive rate at or below a preestablished rate so that data records having unknown determination 232 may be assessed. As such, if unknown record scores 238 meet or exceed semi-supervised cutoff score 236, then the data records may be labeled with inferred bad 216, but if not, may remain in the pool for data records having unknown determination 232.

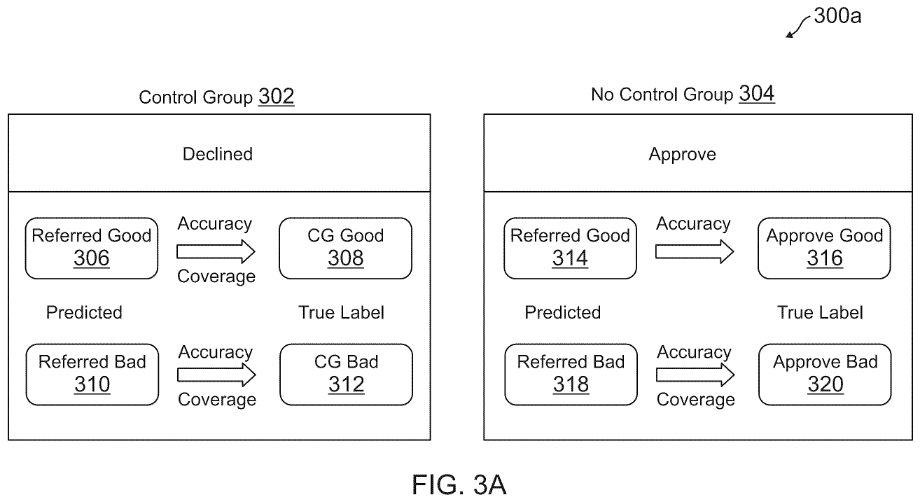

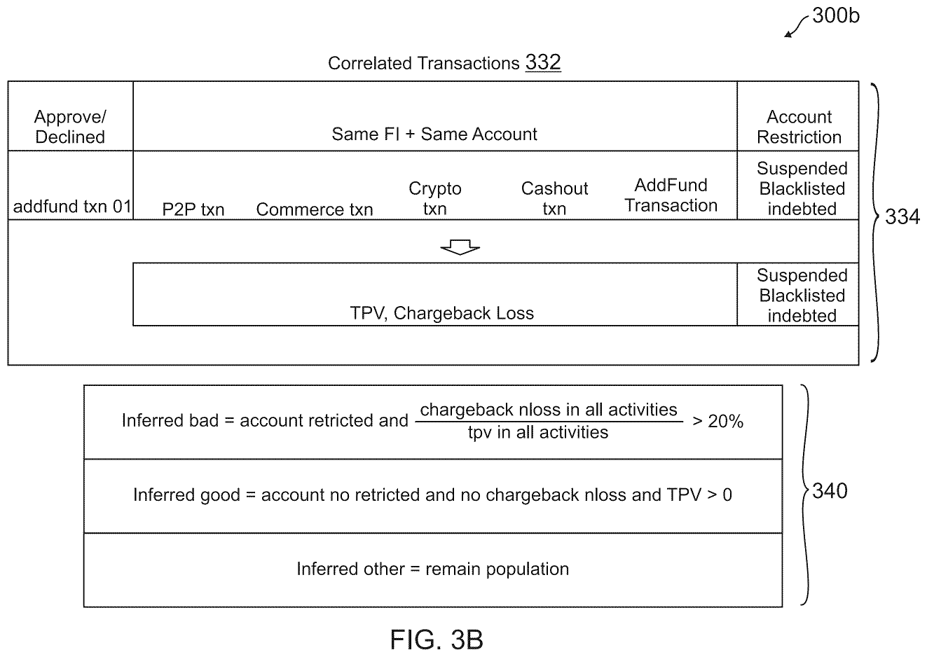

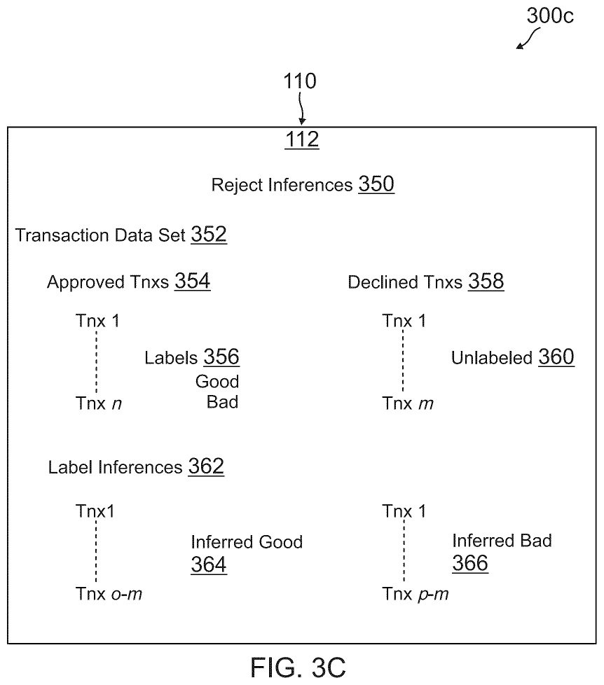

FIGS. 3A-3C are exemplary diagrams 300a-300c showing data and operations that may be used when determining inferences automatically and without user input and tagging based on a riskiness evaluation and/or static AI model score, according to an embodiment. Diagrams 300a and 300b of FIGS. 3A and 3B represent processes for evaluating inferences of annotations of unlabeled data in an excluded data population, as discussed in reference to ML modeling platform 140 of service provider system 130 from system 100 of FIG. 1. Diagram 300c shows a user interface where inferences for rejected transactions or other data records may be displayed to a user for review of the generated training data and data annotations, as well as ML model training based on the generated training data.

In diagram 300a, analysis of transactions labeled from a control group (CG) data set 302 of declined transactions are analyzed with a no CG data set 304 of approved transactions that have labels provided from post-processing of the transactions. In this regard, the analysis of the transactions between the two data sets may be performed in order to determine the accuracy of the labeling or tagging for data annotations of the declined transactions in control group data set 302. With declined transactions in CG data set 302, transactions with predicted annotations for an inferred good label 306 may be processed for accuracy and coverage when compared to true annotations for a CG good label 308, while transactions with predicted annotations of a referred bad label 310 may be processed for similar accuracy and coverage based on true annotations for a CG bad label 312.

Computation of accuracy and coverage for good and bad labels may be computed using the following formula in Equations 1:

$${Accuracy}_{( Good )} = \frac{\# Good correctly predicted}{\# Good predicted} \qquad Equations 1$$

$${Coverage}_{( Good )} = \frac{\# Good correctly predicted}{\# Good total}$$

$${Accuracy}_{( Bad )} = \frac{\# Bad correctly predicted}{\# Bad predicted}$$

$${Coverage}_{( Bad )} = \frac{\# Bad correctly predicted}{\# Bad predicted}$$

Similarly, with the no CG data set 304, transactions with the predicted annotations of referred good labels 314 may be analyzed based on true annotations of approved good labels 316, while predicted annotations of referred bad labels 318 may be analyzed based on true annotations of approved bad labels 320. When evaluating inferences using Equations 1, computation statistical metrics for the comparisons set forth in diagram 300a may be performed for inferred or predicted labels. These analytics may correspond to accuracy and coverage of the predicted labels and may allow for analysis of the evaluation process and metric selected for inferring labels. For example, computation of accuracy for referred good 306 and referred bad 310 in CG data set 302, as well as referred good 314 and referred bad 318 in no CG data set 304, may be used to identify and evaluate how accurate the inferred labels are when predicting the labels using the evaluation processing and metrics (e.g., how many of the labels that were predicted were actually correct), while coverage may demonstrate how many of the labels were actually predicted in total. As such, just accuracy or coverage may not provide sufficient analyses but together the analytics may provide a better evaluation of the criteria and decision-making of the intelligent annotation system discussed herein.

In diagram 300b of FIG. 3B, correlated transactions 332 are shown, which may be processed to infer data labels usable for annotating data records, such as transactions, for ML model training. In this regard, correlated transactions 332 may be given labels or tags for data annotations based on other data records having the same or similar data values for certain variables over a time period, thus indicating a strong correlation between those data records (e.g., where a transaction may have the same funding instrument and user requesting the transaction, may indicate that the transaction originates from the same source). Correlated transactions 332 may be correlated to a transaction of interest, such as an unannotated transaction from an excluded data population, and may be based on matching one or more of variables 334 having the same or similar value in a particular time period of interest (e.g., n minutes, hours, days, before/after the transaction of interest). Once identified, determination of riskiness of the transaction of interest, such as an inferred label or tag of good or bad, may be performed using the following Equations 2. In Equations 2, an inferred bad label may be determined where conditions indicate that an account restriction is present with a ratio of chargeback nloss in all activities to TPV in all activities is greater than 20%, while an inferred good label may be determined when the conditions indicate no account restriction is present with a chargeback nloss and TPV greater than 0. In this regard, chargeback nloss may correspond to the net loss for the company caused by the chargeback dispute being “filled” for this financial instrument, where the chargeback dispute is filled when it is repaid or fulfilled with the customer (e.g., when the customer has received their funds in return or had the unauthorized transaction voided and removed such that the customer receives compensation for or is otherwise made whole again for the disputed transaction). Chargeback disputes are generally filled by the owners for any unauthorized transaction, and therefore, the chargeback nloss may correspond to the amount of the chargebacks or the amount being disputed for return to the customer(s). TPV or tpv may correspond to the total payment volume for the customer or other user, and the ratio of chargeback nloss divided by the TPV may reflect the financial riskiness of this financial instrument if stolen, fraudulently used, or otherwise misappropriated for unauthorized transactions, which may be inferred for other payment processing flows of the same user. All other transactions that do not meet either of these conditions may be inferred as other, or unknown, until further analysis can be conducted.

$$Inferred bad = account retricted and \frac{chargeback nloss in all activities}{tpv in all activities} > 20 \% \qquad Equations 2$$

$$Inferred good = account no retricted and no chargeback nloss and TPV > 0$$

$$Inferred other = remain population$$

In diagram 300c of FIG. 3C, a user interface of application 112 on client device 110 may display reject inferences 350 for data labels, tags, or other annotations that were made by an intelligent data annotation system, as described herein, that may infer the annotations based on correlations to other data records and/or control groups of data records, allowing for annotating of excluded populations of data records for ML modeling and training. In this regard, the user interface that displays reject inferences 350 may provide information for annotations of a transaction data set 352. The information may include annotated data records for approved transactions 354 having labels 356 (e.g., good, bad, etc.) and declined transaction 258 that were not originally processed. As such, declined transactions 358 are shown as unlabeled 360, which may cause declined transactions 358 to make up an excluded data population for ML model training. As described herein, label inferences 362 may be determined for declined transactions 358, which may be used in place of labels 356 determined by a human annotator and used for at least a part of declined transactions 358 initially indicated as unlabeled 360 so that the transactions have labels and may instead be used in the training data set as labeled transactions. Labels for inferred good 364 transactions and inferred bad 366 transactions may therefore replace the status of the corresponding transactions as unlabeled 360 for training data generation. This may be displayed in the user interface that includes reject inferences 350 so that a data scientist or other user involved in training data generation and/or ML model training may review the labels to determine accuracy and coverage for refinement of the training data and/or inferencing system.

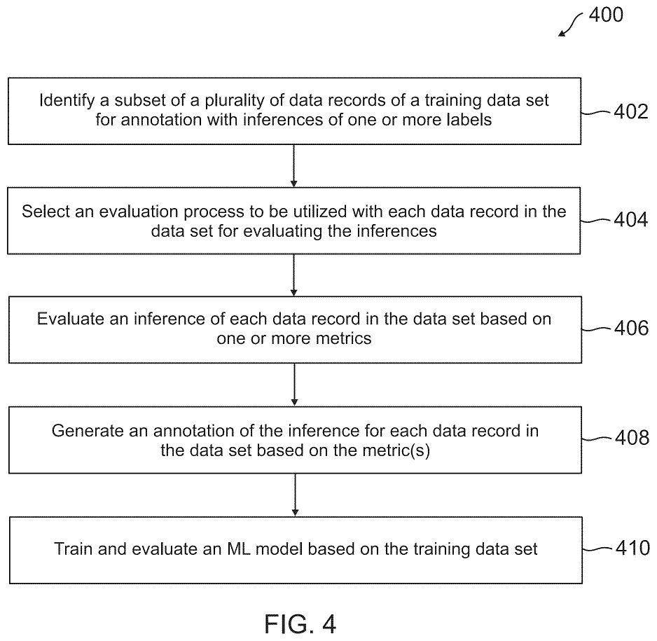

FIG. 4 is a flowchart 400 of steps of an anomalous signal detection using a machine learning pipeline for automated solution generation, according to an embodiment. Note that one or more steps, processes, operations, and methods described herein of flowchart 400 may be omitted, performed in a different sequence, or combined as desired or appropriate.

At step 402 of flowchart 400, a subset of a plurality of data records of a training data set is identified for annotation with inferences of one or more labels. Service provider system 130 may receive transactions 122 via one or more communication channels, through streaming data, and/or through aggregations of transactions 122 and transmission of batches or data sets of transactions 122 for processing. In other embodiments, other data aggregators and/or collectors may aggregate and store transactions 122, and/or training data 114 may be generated based on transactions 122 using data from transactions 122. As such, training data 114 may be selected and/or determined, where training data 114 is requested for use with ML modeling or other AI model generation and/or training process. While a portion of training data 114 may be annotated for training by having corresponding tags or labels that classify the data in accordance with a task being requested to be learned by a machine (e.g., an output classification or prediction for the ML task to be learned), an excluded population of data records or the like from training data 114 may not have corresponding tags, and may therefore require data annotations prior to training using a supervised or semi-supervised ML learning process. Where transactions 122 are used, transactions 122 may require risk and/or fraud analysis and detection to prevent or mitigate fraud, computing attacks, and other malicious behaviors that may be the result of new and/or ongoing fraud patterns, behaviors, activities, or other courses of action.

At step 404, an evaluation process is selected to be utilized with each data record in the data set for evaluating the inferences. Model training 141 for ML modeling platform 140 may include algorithms 142 usable for ML model training and/or other AI model, engine, or system configuring. In this regard, when modeling an ML or other AI model using algorithms 142, annotated training data may be required, and it may be required to label all or part of the excluded data population that a fuller, more comprehensive, and/or more representative training data set may be obtained for model training. As such, training data 114 and/or a domain or other classification of the data records in training data 114 may be used to determine whether a control group is available and/or whether that control group has a static model available for static score determination of each data record in the unannotated and/or excluded data population. Evaluation processes used by training data tool 143 may depend on the control group availability.

For example, if unavailable or in general scenarios, a riskiness evaluation may be performed for data records in the excluded population using correlations to other data records sharing the same or similar trait, characteristic, or property, such as other data records having the same data value for certain variables (e.g., transactions 122 having the same financial instrument used and/or same user as the sender/recipient of payment). These similar data records may be matched for a time period, and it may be determined whether sufficient matching data records are identified to classify the unannotated data record with the same or similar annotation to the matching data records. In some embodiments, this may require analysis of a TPV or loss rate as well when determining the riskiness of the data record, such as by identifying how large of a customer and/or the volume of data transactions are, how much the customer and/or transaction processor may lose per transaction or based on the excluded data record and/or matched data records, and the like. With other data records where a control group is available, a static model may be used to compute a model score, which may be compared to a score cutoff or threshold for riskiness. Those meeting or exceeding the riskiness cutoff may identified as risky and those that do not, may likewise be identified as not risky or the like.

At step 406, an inference is evaluated for each data record in the data set based on one or more metrics. Inferences 144 may be generated by training data tool 143 based on analysis of the unannotated data records using the evaluation process, which may analyze the unannotated data records to infer labels or tags of the tag records and annotate the data records based on comparison to and/or analysis of other similar data records. In some embodiments, the evaluation process may identify similar data records having one or more corresponding variables with matching values, such as the same user for a user variable, or the same financial instrument (e.g., the same identifier corresponding to a payment card, account, digital wallet, etc.) for a payment source variable. With matching data records, a statistical analysis may be performed to determine if there is a sufficient correlation between tags of the matched data records, such as if other transactions having the same financial instrument and same user within a corresponding time period have fraudulent or non-fraudulent transactions, to infer that the tag of those matched record is or should be the same as a tag that can be provided for the unannotated record. Where there is a control group, a static model used with that control group in a production computing environment may be used to determine a model score of the data record and then make one of inferences 144 based on that model score and a score cutoff.

At step 408, an annotation of the inference is generated for each data record in the data set based on the metric(s). After determination of inferences 144, inferred labels 145 may be generated for each of the data records in the excluded population of data records, such as by tagging or labeling the data records in accordance with inferences 144. Annotating the data records may include creating and/or attaching data tags or labels to each data record so that the data record has a corresponding identifier that may be readable and/or processable by an ML model trainer, such as an application or process, which may correlate the identifiers with outputs by the ML model being trained. For example, where the ML model is to be trained to detect fraud, output classifications by the ML model may correspond to “fraudulent” or “non-fraudulent.” As such, with the tags or labels, these annotations may designate and/or identify the previously unannotated data records with corresponding identifiers for “fraudulent” or “non-fraudulent,” enabling the ML model trainer to perform pattern analysis, recognition, and inferencing on further data records based on detected patterns and other learned characteristics and properties of the labeled training data set. Since the training data set includes labels that are machine-annotated and not the result of human annotation, ML model training on such annotated data may not be considered “supervised” in the conventional sense and instead be identified as “semi-supervised” from the original included population of data records annotated by a human after processing and the excluded population of data records now annotated by the automated process.

At step 410, an ML model is trained and evaluated based on the training data set. Once the excluded population of data records has been analyzed and labeled based on inferences from other past data records sharing the same or similar data (e.g., having the same or similar values for certain selected data variables), the training set may be considered to be “matured” or ready for ML model training. One or more of algorithms 142 may be applied to training data 114 having inferred labels 145, which may be used to configure one or more data processing nodes, layers, trees and branches, clusters, and the like during model training. Configuring may include determining and/or adjusting activation functions, weights, and the like that may be applied during automated and intelligent data processing and inferences. The resulting model may then be analyzed for accuracy and/or other model performance metrics, which may be provided in a model summary. A user of the service provider involved with model deployment may then consider whether the models perform sufficiently well for production deployment.

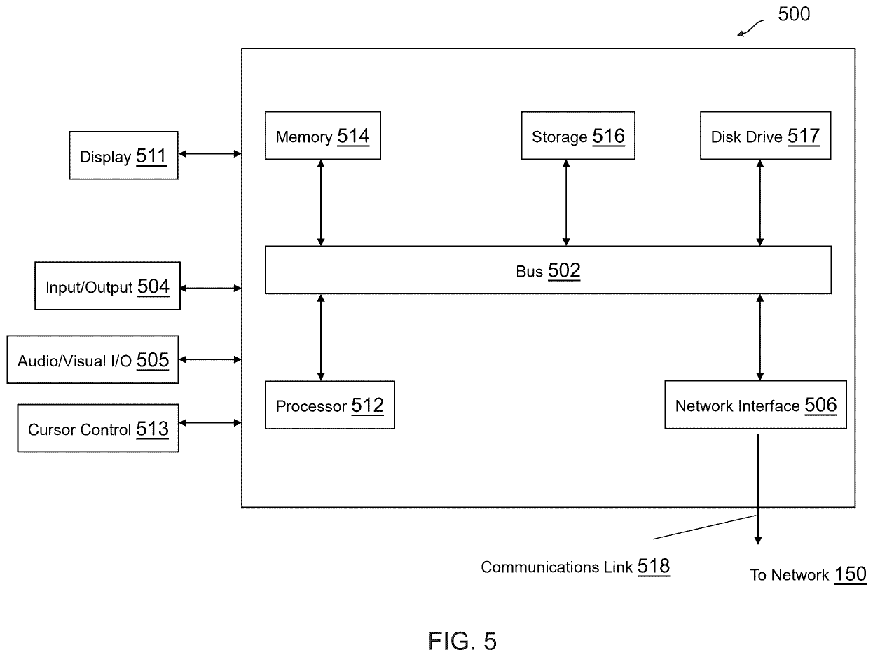

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, images, or links, and/or moving one or more images, etc., and sends a corresponding signal to bus 502. I/O component 504 may also include an output component, such as a display 511 and a cursor control 513 (such as a keyboard, keypad, mouse, etc.). An optional audio/visual input/output (I/O) component 505 may also be included to allow a user to use voice for inputting information by converting audio signals and/or input or record images/videos by capturing visual data of scenes having objects. Audio/visual I/O component 505 may allow the user to hear audio and view images/video including projections of such images/video. A transceiver or network interface 506 transmits and receives signals between computer system 500 and other devices, such as another communication device, service device, or a service provider server via network 150. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method comprising:
obtaining, from a data set, a first data subset for a declined data group and a second data subset for an approved data group, wherein the data records in the declined data group are unannotated for an analysis to be performed by a machine learning (ML) model;
determining that the ML model is to be trained using the data set having first annotations for the first data subset and second annotations for the second data subset, wherein the first annotations are to be generated for the first data subset, and wherein the second annotations were previously provided for the second data subset;
selecting one of a plurality of evaluation processes available for evaluating a metric associated with a declined event corresponding to the data records in the declined data group;
evaluating the metric for the data records in the declined data group using the one of the plurality of evaluation processes;
generating first annotations for the first data subset based on the evaluated metric, wherein the first annotations comprise one of a first type of annotation or a second type of annotation for each of the data records in the declined data group based at least on the evaluated metric; and
training the ML model using the data set with the first annotations and second annotations for the second data subset.

2. The method of claim 1, wherein the first annotations comprise automated annotations performed independent of user input associated with tagging the data records in the first data subset, wherein the second annotations comprise manual tags by one or more users of the approved data group of the data records after an approval of each of the data records in the approved data group, and wherein the training is performed using a semi-supervised ML training process associated with the manual tags.

3. The method of claim 1, further comprising:
computing a loss rate from processing each of the data records in the declined data group in a data processing flow,
wherein the metric is evaluated based on the loss rate.

4. The method of claim 3, wherein the data processing flow is provided using a computing service of a service provider to a plurality of users associated with the data records.

5. The method of claim 1, wherein the one of the plurality of evaluation processes comprises a model scoring process that uses a static ML model and a control group of the declined data group.

6. The method of claim 5, further comprising:
receiving a selection of the static ML model for the model scoring process from a plurality of ML models used for one or more analyses of the data set in a transaction processing flow; and
establishing the control group and the static ML model for the model scoring process.

7. The method of claim 1, wherein, prior to the generating the first annotations, the method further comprises:
determining an inference for each of the data records in the first data subset using the metric and one or more thresholds for two or more tags for the first annotations; and
associating the inference with one of the two or more tags.

8. The method of claim 7, wherein the one or more thresholds include at least one of a first threshold, a second threshold higher than the first threshold, or a third threshold higher than the second threshold.

9. The method of claim 1, wherein the generating the first annotations is performed on unlabeled data from the first data subset where labeling does not occur if a data processing of the unlabeled data is declined or terminated prior to completion, and wherein labeled data in the second data subset occurs after the data processing based on a review process of the data records in the second data subset after the data records in the second data subset were approved or proceeded to be processed.

10. The method of claim 1, further comprising:
outputting the trained ML model with at least one model performance metric responsive to the training the ML model, wherein the at least one model performance metric is associated with at least the first annotations and computed for the trained ML model.

11. A system comprising:
a non-transitory memory; and
one or more hardware processors coupled to the non-transitory memory and configured to read instructions from the non-transitory memory to cause the system to perform operations comprising:
determining an evaluation process and a metric for evaluating a plurality of data records for a plurality of data processing events that were previously requested to be processed, wherein the plurality of data records correspond to a first subset included in a data set that further includes a second subset of a second plurality of data records having user annotations only to other data records in the second subset;
determining an inference associated with at least one activity for each of the plurality of data records using the metric corresponding to each of the plurality of data records;
generating an annotation associated with the inference for each of the plurality of data records;
training a first machine learning (ML) model for an automated detection associated with the at least one activity using the data set having the generated annotation for each of the plurality of data records in the first subset and the user annotations for the other data records in the second subset;
determining a performance of a first ML model in a computing environment associated with executing the first ML model; and
outputting the performance of the first ML model responsive to the training.

12. The system of claim 11, wherein the evaluation process uses one of a comparison with annotated data records over a time period or a static ML model, and wherein the metric comprises one of a loss rate usable for the comparison or a score cutoff threshold for the static ML model.

13. The system of claim 11, wherein the determining the performance of the first ML model includes computing one or more performance metrics of at least one of the first ML model or the generated annotations for each of the plurality of data records in the first subset.

14. The system of claim 13, wherein the one or more performance metrics for the generated annotations comprise at least one of an accuracy of the generated annotations based on a number of the generated annotations that are correct and a first total number of the generated annotations or a coverage of the generated annotations based on the number of the generated annotations that are correct and a second total number of all of correspondingly labeled annotations.

15. The system of claim 11, wherein the at least on activity is associated with one of a fraud detection or an account takeover detection.

16. The system of claim 11, wherein the plurality of data records comprises a transaction data set of past transactions, and wherein the transaction data set includes approved transactions that are labeled and declined transactions that are unlabeled.

17. The system of claim 11, wherein the operations further comprise:
executing the first ML model in the computing environment for the automated detection.

18. A non-transitory machine-readable medium having stored thereon machine-readable instructions executable to cause a machine to perform operations comprising:
selecting one of a plurality of evaluation processes usable for evaluating a metric associated with an event corresponding to data records in a first data set, wherein the event is associated with declining to approve processing of the data records in the first data set using a data processor of a computing service;
evaluating the metric of the data records in the first data set using the one of the plurality of evaluation processes, wherein the evaluating comprises inferring whether each of the data records belongs in the first data set based on the metric and any correlations between each of the data records and other data records occurring within a time period;
generating first annotations of the data records in the first data set based on the evaluating; and
training a machine learning (ML) model using the first data set having the first annotations and a second data set having second annotations provided based on processing the second data set using the data processor of the computing service.

19. The non-transitory machine-readable medium of claim 18, wherein the computing service comprises an electronic transaction processing service, and wherein the data processor comprises a transaction processor.

20. The non-transitory machine-readable medium of claim 18, wherein the operations further comprise:
determining a cutoff score for inferences determining by the ML model based on an acceptable false positive rate set for the ML model.
